(19) United States
(12) Patent Application Publication
(10) Pub. No.: US 2005/0255724 A1
(43) Pub. Date: Nov. 17, 2005

(54) Flexible leak detection sensor

(75) Inventors: David Picco, Carlsbad, CA (US); Ibrahim Hanna Makhlouf, Fullerton, CA (US); Jeffery Ross Gray, San Diego, CA (US)

Correspondence Address: Gerald Maliszewski, P.O. Box 270829, San Diego, CA, 92198-2829, US

(73) Assignee: Touridan Inc.

(21) Appl. No.: 11/186,216

(22) Filed: Jul. 21, 2005

Related U.S. Application Data
(63) Continuation-in-part of application No. 11/115,658, filed on Apr. 27, 2005.
(63) Continuation-in-part of application No. 10/804,304, filed on Mar. 19, 2004.
(60) Provisional application No. 60/590,588, filed on Jul. 23, 2004.

(51) Int. Cl. H01R 12/00

(52) U.S. Cl. 439/77

(57) ABSTRACT

A flexible liquid detection sensor is provided comprising a flexible dielectric sheet. A detection field, formed from a pair of conductive traces overlies a first surface of the flexible dielectric sheet, having a resistance responsive to a liquid overlying the conductive traces. The conduction field has an impedance characteristic independent of the selected length of the dielectric sheet. Therefore, the sensor can be cut to almost any length, without the sensor length impacting the liquid sensing resistance measurements. In one aspect, conventional electrical wires can be soldered to the traces to form an electrical interface with the monitoring and alarm equipment. Alternately, the connector may include a clamping mechanism to physically secure the connector to the flexible dielectric sheet, along with an electrical interface that includes pins, to at least partially penetrate the dielectric sheet and engage the conductive traces, in response to securing the clamping mechanism.

### RELATED APPLICATIONS

This application claims the benefit of a provisional patent application entitled, FLEXIBLE SURFACE-CONTOURED LEAK DETECTION SENSOR, invented by Picco et al., Ser. No. 60/590,588, filed Jul. 23, 2004.

This application is a continuation-in-part of a pending patent application entitled, VESSEL LIQUID OVERFLOW DETECTOR, invented by Picco et al., Ser. No. 11/115,658, filed Apr. 27, 2005.

This application is a continuation-in-part of a pending patent application entitled, SYSTEM AND METHOD FOR DETECTING WATER LEAKAGE, invented by Picco et al., Ser. No. 10/804,304, filed Mar. 19, 2004.

### BACKGROUND OF THE INVENTION

1. Field of the Invention

This invention generally relates to emergency alarm sensors and, more particularly, to a flexible pipe-wrapped or surface-contoured sensor for detecting water or plumbing leaks.

2. Description of the Related Art

Plumbing failures in residential and commercial building result in millions of dollars of damage each year, in this country alone. As a result, systems have been designed to detect pools of water or leakage from a pipe. For example, conductive liquid sensors are known that consist of two electrically conductive materials formed on an insulating material in close proximity, but without touching. When liquid is sensed across the two conductive materials, the resistance between the conductive materials drops. This reduction in resistance is monitored, and a decrease in resistance can indicate the presence of liquid. This method provides an economical means to sense liquid on floor surfaces due to leaks in pipes, failed fittings, leaking valves, and floods.

Many sensors are essentially two-dimensional. They can be located over a wall or a floor, for example, to detect the presence of water. However, these sensors are not sufficiently subtle to detect a leak in all conditions, or on all surfaces. For example, a flat two-dimensional floor sensor, mounted on a tile, may be unable to detect water leaking through the grooves between tiles. Likewise, a rigid sensor that can only be mounted to a first side of a pipe may be unable to detect water that is running down a second side of the pipe, away from the sensor.

It would be advantageous if a liquid detection sensor could be made flexible, so that it can be mounted to the contour of detection surfaces, seated in the grout channels between floor tiles, mounted under wooden floor boards, or wrapped around pipes.

It would be advantageous if the length of the above-mentioned contour-mounted sensor could be made selectable, so that it can be trimmed to fit a surface, without impacting the default sensor resistance measurement characteristics.

### SUMMARY OF THE INVENTION

Described herein is a sensor that can be fabricated by the roll and cut on the job to fit the situation. The selectable-length sensor is flexible enough to be contoured to match almost any surface. This sensor solves many of the problems associated with the above-mentioned two-dimensional sensors.

Accordingly, a flexible liquid detection sensor is provided comprising a flexible dielectric sheet with a surface and a length. A detection field, formed from a pair of conductive traces overlies the first surface of the flexible dielectric sheet, having a resistance responsive to a liquid overlying the conductive traces. The conduction field has an impedance characteristic independent of the selected length of the dielectric sheet. Therefore, the sensor can be cut to almost any length, without the sensor length impacting the liquid-sensing resistance measurements.

In one aspect, conventional electrical wires can be soldered to the traces, forming an electrical interface to the monitoring and alarm equipment. Alternately, the connector may include a clamping mechanism to physically secure the connector to the flexible dielectric sheet, along with an electrical interface that includes pins, to at least partially penetrate the dielectric sheet and engage the conductive traces, in response to securing the clamping mechanism. This kind of clamping connector is often used with low voltage Malibu lighting kits, for example, to electrically connect individual lights to a main bus line.

In another aspect, an adhesive strip can be attached to an end of the dielectric sheet, to secure the sensor to a surface. Alternately, a clamping mechanism, such as a cable tie, can be attached to the dielectric sheet first surface, to wrap and secure the sensor around a circumference of a radial object such as a pipe.

Additional details of the above-described flexible sensor are provided in greater detail below.

### BRIEF DESCRIPTION OF THE DRAWINGS

FIG. 1 is a partial cross-sectional view of a flexible liquid detection sensor.

FIG. 2 is a plan view of the sensor of FIG. 1.

FIG. 3 is a perspective drawing showing sensor of FIG. 2 mounted around a pipe, with a soldered electrical interface.

FIG. 4 is a perspective drawing showing a pre-fabricated type of connector that can be quickly attached to the dielectric strip, without the need for soldering.

FIGS. 5A and 5B are partial cross-sectional views of the sensor of FIG. 1 with a first variation of a surface attachment mechanism.

FIG. 6 is a partial cross-sectional view of a second variation of a surface attachment mechanism.

FIGS. 7A and 7B are orthogonal partial cross-sectional views of a third variation of a surface attachment mechanism.

FIG. 8 is a plan view of sensor where the detection field includes a pair of conductive traces formed in a “zipper” pattern.

FIG. 9 is a partial cross-sectional view of an additional feature that can be added to the sensor to address the problem of condensation.

FIGS. 10A, 10B, and 10C are partial cross-sectional views of a feature that can be added to the sensor to address the problem of conductive debris in the detection field.

FIG. 11 is a perspective view of a feature that can be added to the sensor to address the problem of testing the sensor integrity.

FIG. 12 is a plan view showing a sensor with a connector mounted to each connector end.

FIG. 13 is schematic block diagram of a wallplate sensor controller.

### DETAILED DESCRIPTION

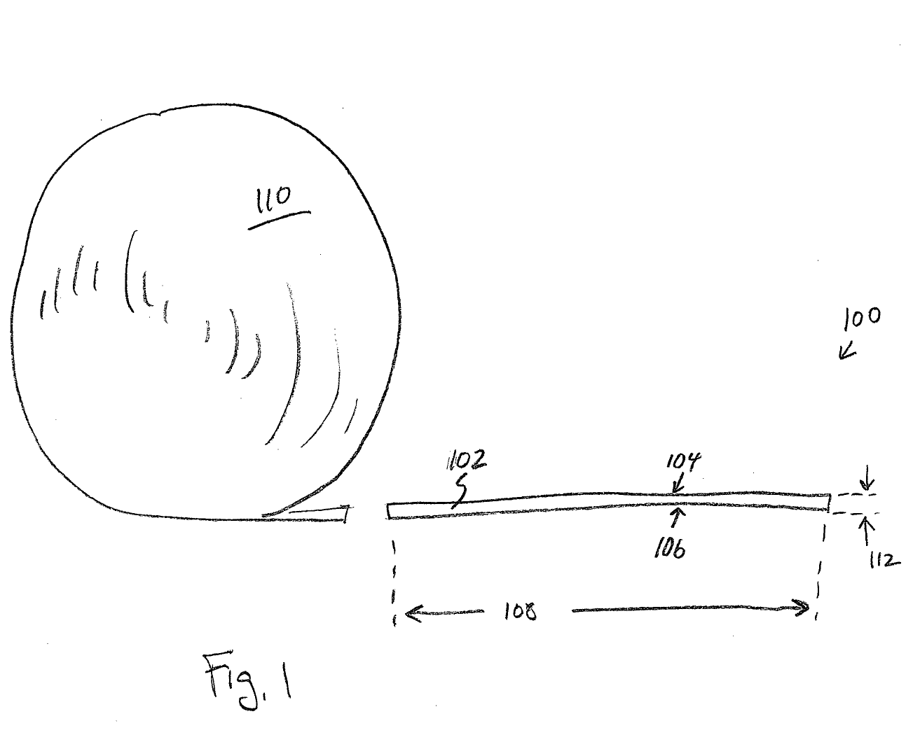

FIG. 1 is a partial cross-sectional view of a flexible liquid detection sensor. The sensor 100 comprises a flexible dielectric sheet 102 with a first surface 104 and a second surface 106. The sheet 102 has a length 108. As shown, the strip's length 108 is formed by cutting a section of sheet 102 from a longer roll of material 110. For example, the dielectric sheet 102 may be a material such as paper, tape, or an insulating film. Alternately, the material can be a polyester or polyimide film, such as Mylar® or Kapton®. Other material choices include a synthetic aromatic polyamide polymer, such as Nomex®. Further, phenolic sheets or polytetrafluoroethylene (PTFE), such as Teflon®, may be used. Chlorosulfonated polyethylene (i.e., Hypalon®), silicon sheets, ethylene propylene diene monomer (EPDM) are also good material choices. However, the sensor is not limited to any particular material. A number of other conventional materials could be used to enable the invention. For example, conductive traces formed from a trimmed or etched foil of copper or aluminum tape, with or without an adhesive backing, may be used as a flexible sensor.

In one aspect, the dielectric sheet 102 is a polyimide film (i.e., Kapton®, manufactured Dupont) having a thickness 112 of about 3 mils. One advantage of polyimide is its resistance to high temperature, so that the sensor can be durably mounted around hot water pipes. The thickness 112 may be modified in consideration of factors such as strength, flexibility, the ability of the dielectric material to conform to detection surface contours, and the ease with which the dielectric sheet length can be trimmed.

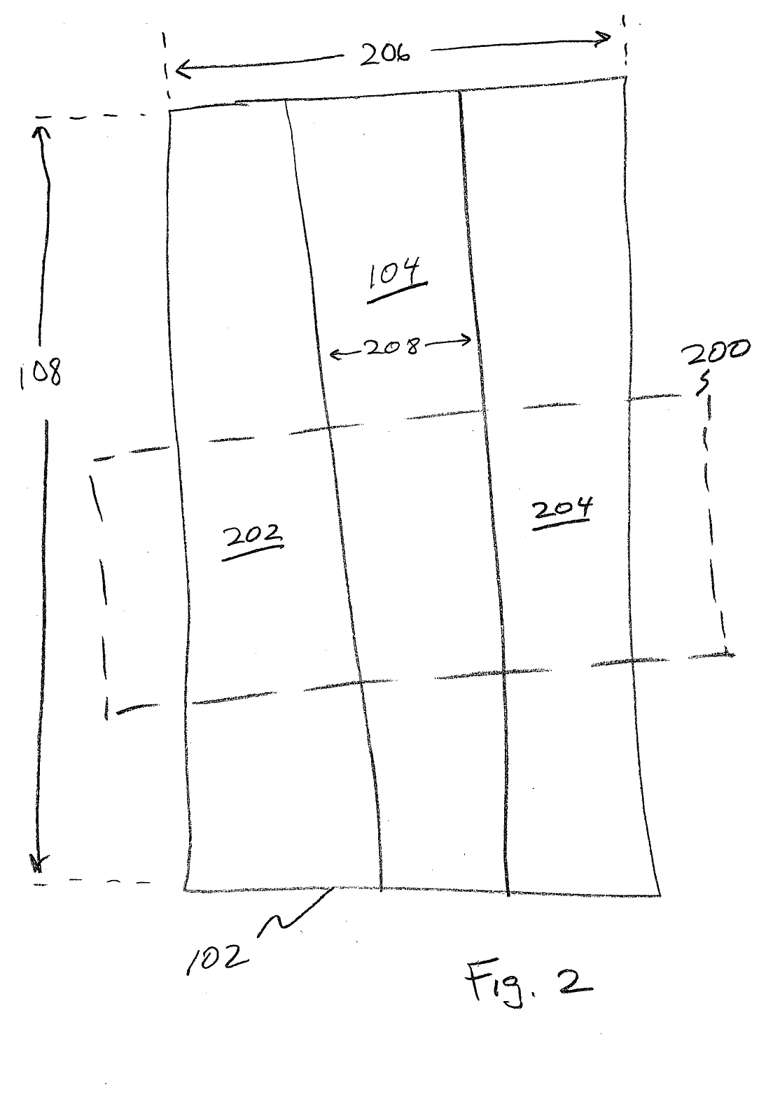

FIG. 2 is a plan view of the sensor of FIG. 1. A portion of a detection field is labeled with reference designator 200. The detection field 200 is formed from a pair of conductive traces 202 and 204 overlying the first-surface 104 of the flexible dielectric sheet 102. The detection field 200 has a resistance responsive to a liquid overlying the conductive traces. The conduction field 200 has an impedance characteristic independent of the length 108 of the dielectric sheet. In one aspect, the dielectric sheet 102 has a width 206 of about 1 inch. The width 206 may be varied in response to a desired mechanical strength, or a desired resistance. The resistance is dependent upon the distance 208 between conductive traces 202 and 204. The detection field conductive traces may be an exposed conductive ink printed on the dielectric sheet first surface. It is known to use conductive ink in the fabrication of electric circuitry on t-shirts, toys, and disposable electronics. These inks permit low-cost offset printing processes to be used in large-scale manufacturing. Such inks are manufactured by T-Ink, Seiko Epson, and E Ink, to name a few manufacturers.

Alternately, the traces can be exposed gold, copper, or a copper/tin alloy. The conductive traces can be a material such as 1 ounce, or 0.5 ounce copper. The copper may be treated to resist corrosion. For example, the copper may be gold flashed. However, the invention is not limited to any particular type of conductive material.

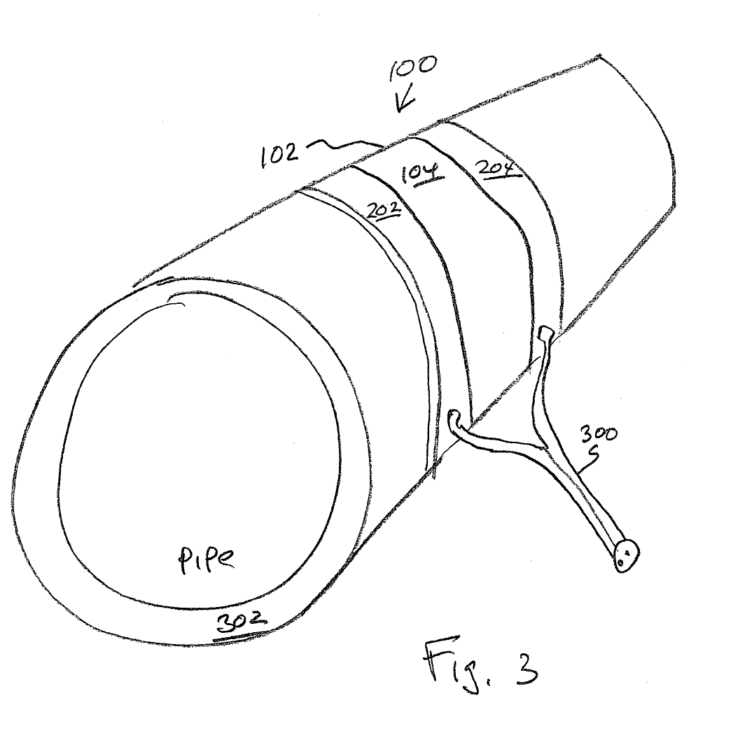

FIG. 3 is a perspective drawing showing sensor of FIG. 2 mounted around a pipe, with a soldered electrical interface. As shown, conventional copper wiring 300, covered with insulation, has been soldered to conductive traces 202 and 204. The wire harness (2 wires) supplies a resistance measurement responsive to liquid in the detection field, to monitoring/alarm equipment (not shown). In this simple form of the invention, the dielectric strip 102 is cut from a roll, and physically secured by wrapping around a pipe 302. Once secured, the wires can be soldered to a convenient exposed portion of the conduction field. Liquid leaking from the pipe 302 may penetrate a covered section of the detection field (not shown), or overflow an exposed section of the detection field underneath the pipe.

In one aspect, the dielectric sheet 102 may be trimmed to fit about one turn around the pipe. Less than a complete turn may permit water to leak down the pipe, in a pipe region not covered by the sensor, without contacting the sensor. More than a complete turn may cover the traces directly adjacent the pipe with an over-wrapping sensor layer, while the over-wrapping sensor layer may sit too high to contact liquid that is leaking down the pipe.

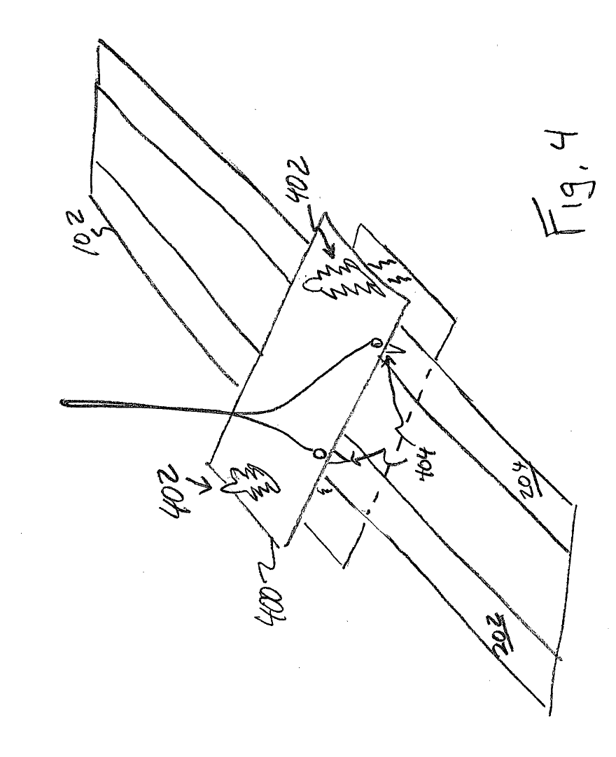

FIG. 4 is a perspective drawing showing a pre-fabricated type of connector that can be quickly attached to the dielectric strip, without the need for soldering. Generally, the connector 400 has a physical interface to mechanically secure a wiring harness to the dielectric sheet, and an electrical interface connected to the detection field to supply a resistance measurement responsive to liquid in the detection field. The connector physical interface is connectable at any position along the dielectric sheet length. The connector electrical interface supplies a resistance measurement independent of the connector physical interface position.

More specifically, the connector physical interface can be a clamping mechanism 402 to physically secure the connector to the dielectric sheet 102. A variety of simple, inexpensive clamping mechanisms are known conventionally, that could be adapted for use with the flexible sensor. For example, the connector may hold the dielectric strip between mating sections by friction, by passing a connecting member through the dielectric sheet, by passing a connection member through the conductive traces (as part of the electrical interface), or combinations of all three. In one aspect, one or more nonconductive connecting members, attached to one mating section, are compression fit into collars formed in the other mating section. Preferable, the members are formed to not intercept or break a run of conductive trace.

In another aspect, the electrical interface includes conductive pins 404, to at least partially penetrate the dielectric sheet and engage the conductive traces 202/204, in response to securing the clamping mechanism. Alternately, the electrical interface is made through a contact that is pressure or friction mated to the conductive traces.

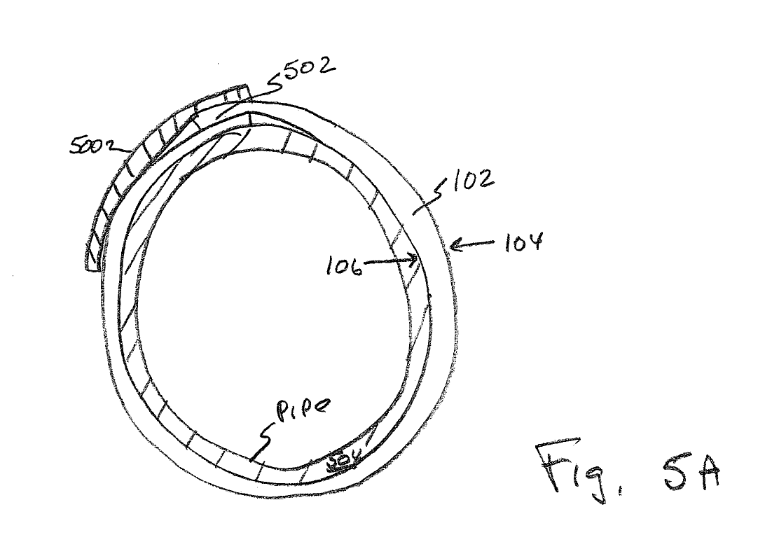

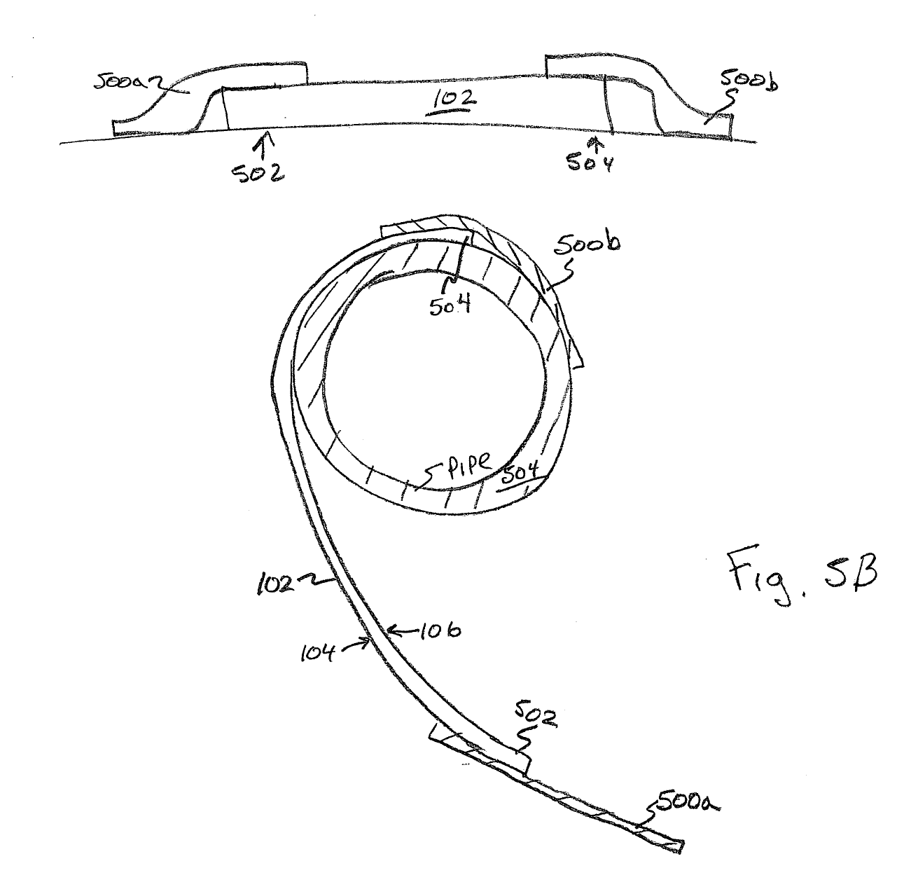

FIGS. 5A and 5B are partial cross-sectional views of the sensor of FIG. 1 with a first variation of a surface attachment mechanism. An adhesive strip 500 (in cross-hatch) is attached to an end 502 of the dielectric sheet 102, to secure the sensor to a surface. The adhesive strip 500 can be attached to either the first surface 104 (as shown) or the second surface 106. In FIG. 5A, the sensor 100 is shown wrapped around a pipe 504. Once the sheet is wrapped and the adhesive strip is adhered to the sheet, the adhesive strip 500 keeps the dielectric sheet 102 from unwrapping.

In FIG. 5B, an adhesive strip 500a is formed on the end 502 of the dielectric sheet 102. In addition, a second adhesive strip 500b is formed on end 504. One strip (500b) is used to hold the sensor to the pipe 504. Once wrapped, strip 500a keeps the sensor from unwrapping. Also shown is a sensor 100 being attached to a flat surface, such as a floor or a wall, using the two adhesive strips.

The adhesive strips can be attached to the dielectric sheet after it is cut from a roll (see FIG. 1). Alternately, the dielectric sheets can be formed in predetermined lengths, with one or two adhesive strips already attached to minimize installation efforts.

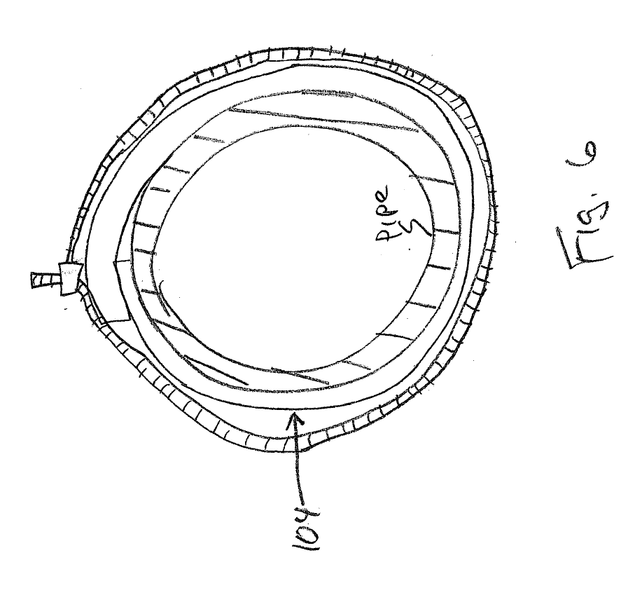

FIG. 6 is a partial cross-sectional view of a second variation of a surface attachment mechanism. More specifically, this attachment means is a clamping mechanism attached to the dielectric sheet first surface 104, to wrap and secure the sensor around a circumference of a radial object, such as pipe. Here, the clamping mechanism is a cable tie that is either threaded through the dielectric sheet (not shown), or attached (i.e., glued) to the first surface 104. Once the sensor is wrapped around the pipe, the cable tie is mated to itself as is conventional, and pulled taut to hold the sensor in place. Alternately, the clamping mechanism is an adhesive strip (as shown in FIG. 5A), a tie wrap, a hose clamp, a twist tie, Velcro strip, Velcro tie wrap, a wire, or a string.

As with the variations of FIGS. 5A and 5B, the dielectric sheet can be cut in predetermined lengths, with specific lengths designed for use with particular pipe outer diameters (ODs). For example, sensors having a precut length of about 1.5 inches may be used for 0.5 inch OD pipe, while a sensor precut to about 4 inches may be used for a pipe with an OD of 3 inches.

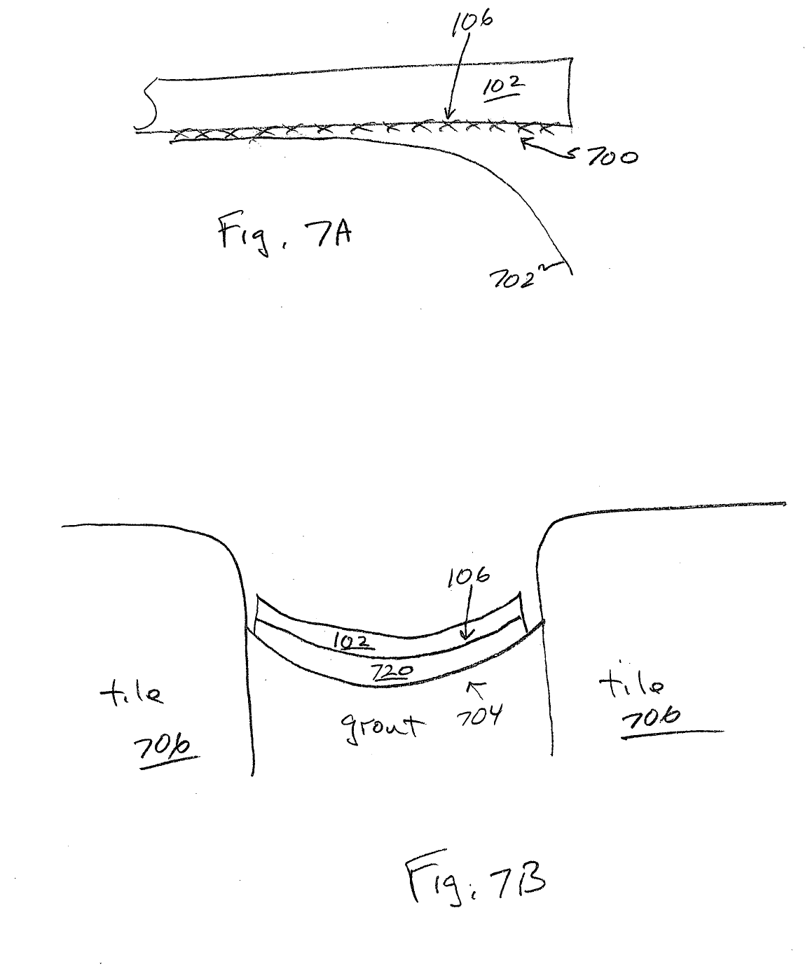

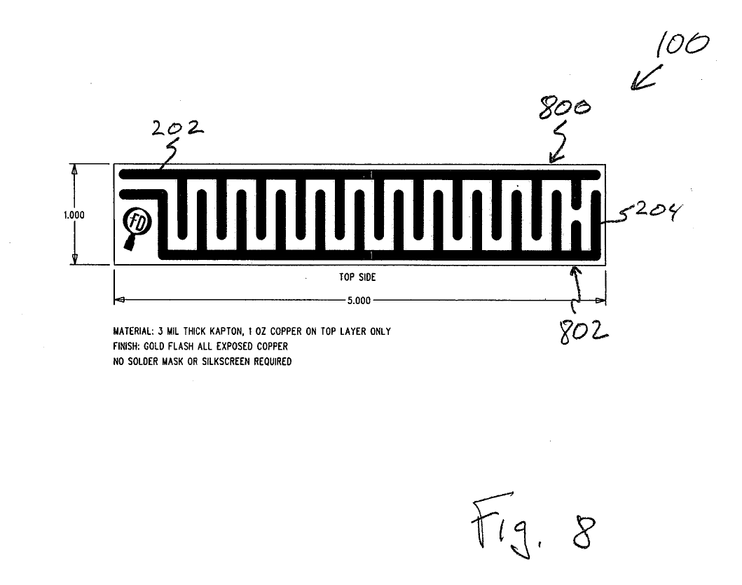

FIGS. 7A and 7B are orthogonal partial cross-sectional views of a third variation of a surface attachment mechanism. An adhesive 700 can be directly formed on the dielectric sheet second surface 106 (FIG. 7A). Some examples of generic adhesives that can be used include acrylic, filled acrylic, and thermosetting rubber. Products such as 3M A 35 Medium Firm Acrylic or 3M 200 MP are specific examples of such adhesives. As shown, a slick peel-off release liner 702 can be loosely adhered to the self-adhesive dielectric sheet until installation, when the release liner 702 is peeled away. In this instance, the dielectric sheet 102 is a tape or insulating film with adhesive backing, with conductive traces formed on one side of the tape, i.e., along the edges of non-sticky side of the tape. One example of a tape with release liner is 3M 9755 transfer adhesive tape.

Alternately (FIG. 7B), an adhesive transfer tape 720 is attached to the dielectric sheet 102 second surface 106. For example, the tape can be 3M tape, part number F9469PC. One advantage of this tape material is its ability to withstand high temperatures, so that the tape can be used to secure the sensor to hot water pipes, or other high temperature surfaces. However, the invention is not necessarily limited to just the above-mentioned types of tapes. Further, the tape may be used to temporarily hold the sensor in place until a tie-wrap, or similar over-wrap mechanism can be applied to the sensor. When an over-wrap is used, the integrity of the tape is less critical.

A sticky sensor surface, however formed, allows the sensor to be securely wrapped around a pipe. As shown in FIG. 7B, the sensor can also be seated in the grout channel 704 between adjoining floor tiles 706, as a leaking liquid is likely to run along the low point of the floor, in the channels. Note, the sensor need not necessarily be smaller in width that the grout channel as shown.

FIG. 8 is a plan view of sensor where the detection field includes a pair of conductive traces 202/204 formed in a “zipper” pattern. Although the parallel conductive trace pattern of FIG. 2 is simple, there are limitations. If the strip is made wide for mechanical strength, then the traces may too far apart for the optimal resistance measurements. If the traces are made wider, to narrow the separation between traces, then the flexibility of the strip may be impaired. The zipper pattern permits the strip to be made wide, while the conductive traces remain narrow. Further, the pattern still permits a connector to be attached anywhere along the length of the strip. That is, even though the traces appear to meander, a connection can always be made with each trace along edge strip areas 800 and 802. The sensor 100 may be enabled with other types of conduction patterns, i.e., a saw-tooth or serpentine pattern, which may perform similarly.

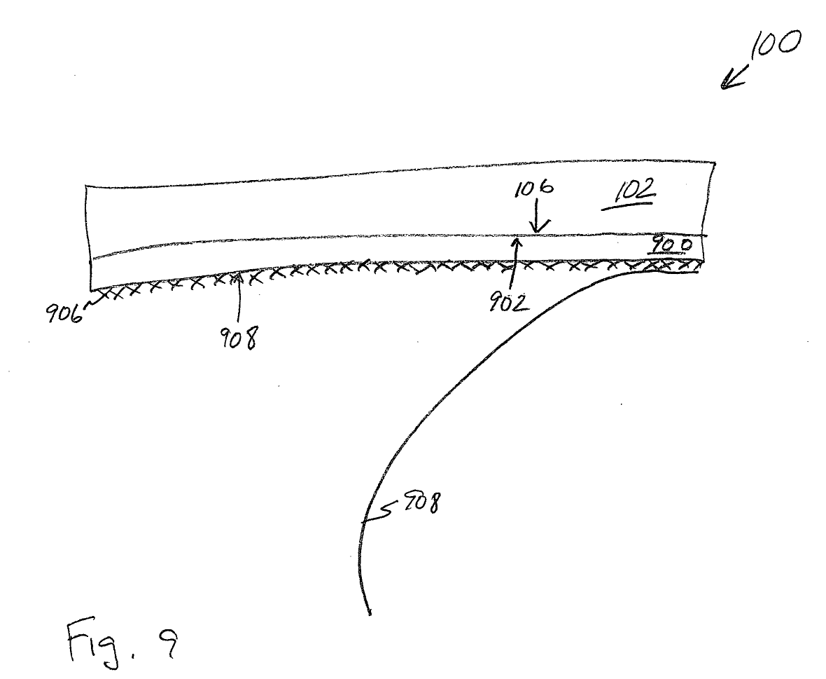

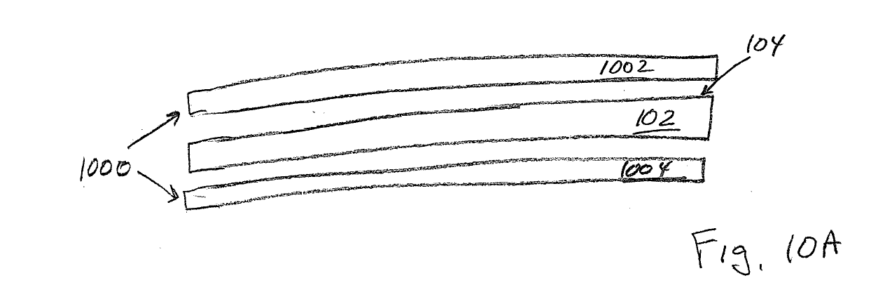

FIG. 9 is a partial cross-sectional view of an additional feature that can be added to the sensor to address the problem of condensation. There are situations when it is normal for a small amount to liquid to accumulate on a surface. For example, a pipe carrying cold water can be expected to “sweat” in hot and humid ambient conditions. In this scenario, a sensor that is closely coupled to the cold pipe will track the temperature of the pipe, causing sweat to form in the detection field and triggering a false leakage alarm. Therefore, in one aspect, a thermal insulation sheet 900 is attached to the dielectric sheet 102 second surface 106. For example, the thermal insulation sheet first surface 902 may be adhered to the second surface 106 with an adhesive. Adhesive 906 may be formed on the thermal insulation sheet second surface 908, to secure the sensor 100 to a surface, such as a pipe. As shown, a peel-off release liner 910 may be loosely adhered to surface 908 until the senor is to be installed.

“Foamy” materials with a high air content can be used as a thermal insulator, while not significantly impacting the overall sensor flexibility. Generically, thermal insulator materials may include ester urethane, EPDM sponge rubber, and neoprene (polychloroprene synthetic rubber), which may be used with silicon, acrylic, or other adhesives. For example, 3M VHB™ is an acrylic foam tape that comes with an adhesive backing that can be used to secure the foam tape to the dielectric sheet, or the adhesive backing can be used to secure the combination of a dielectric sheet/thermal insulator to a liquid detection surface.

Liquid-permeable materials such as cardboard, burlap, cotton cloth, synthetic cloth, paper, and cheesecloth may also be used. However, there is no requirement that the materials be liquid-permeable. In fact, it is often desirable to use non-permeable thermal materials.

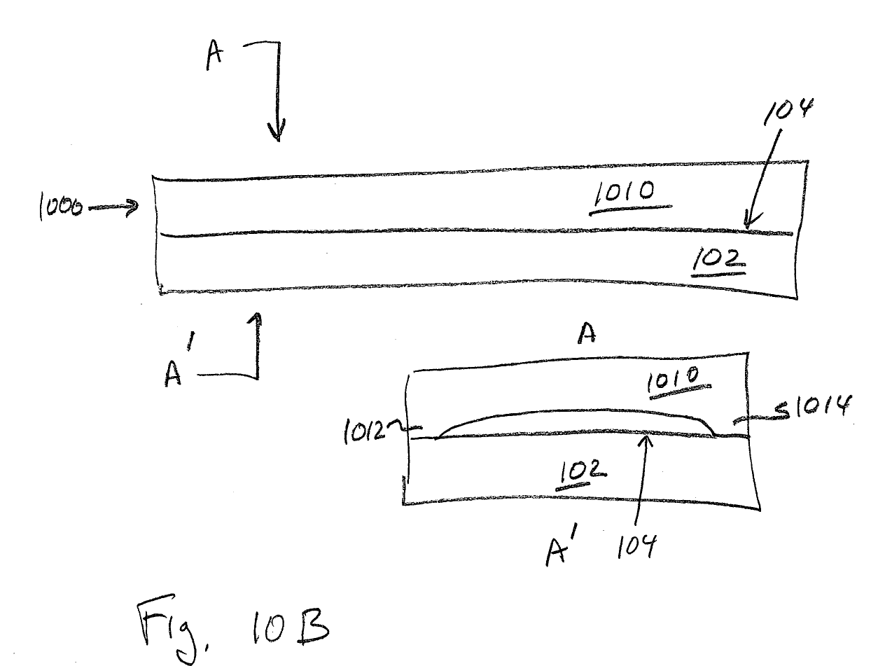

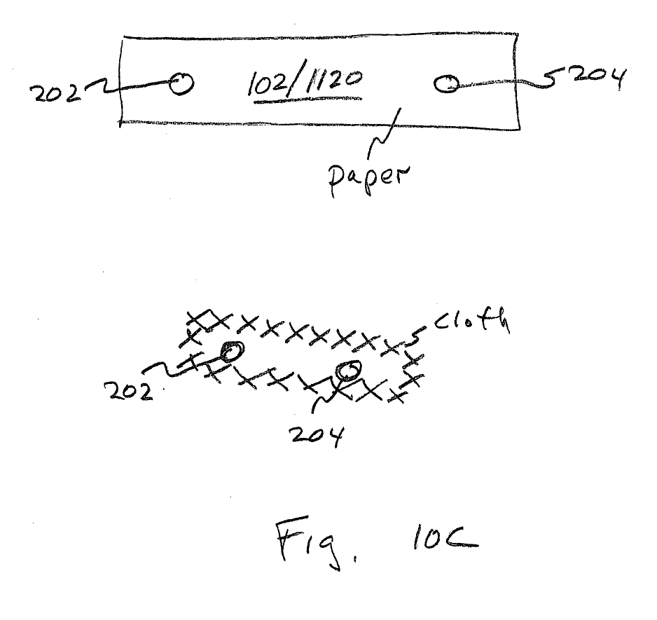

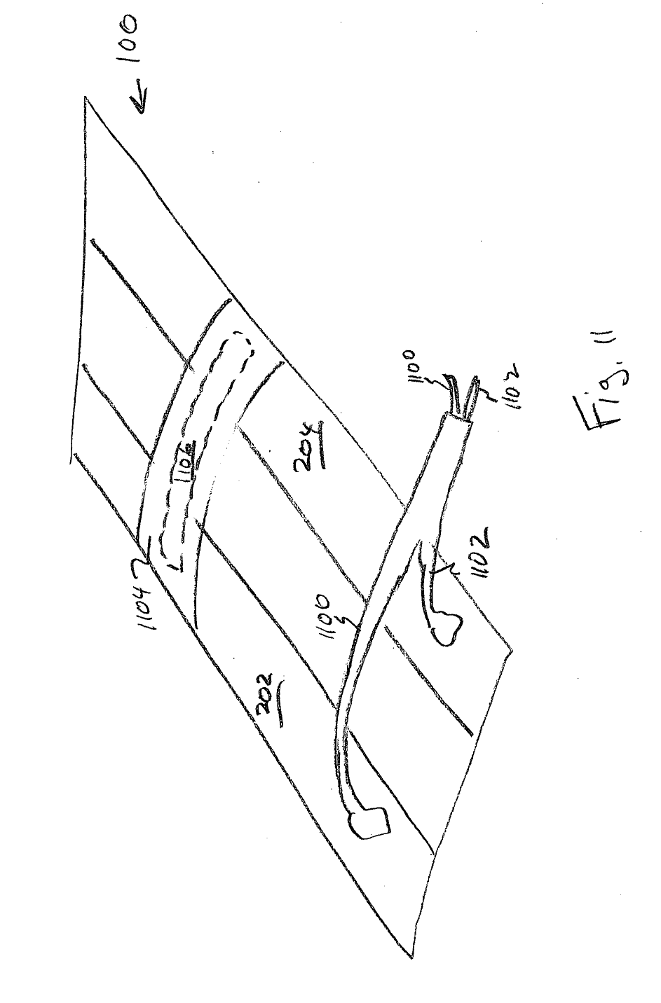

FIGS. 10A, 10B, and 10C are partial cross-sectional views of a feature that can be added to the sensor to address the problem of conductive debris in the detection field. The liquid detection sensor described herein made be attached to inside wall studs and pipes in residential and commercial buildings. As is often the case in construction, jobs are performed by different crews. Therefore, it is likely that debris such as nails, may be inadvertently left on the sensors by one crew, after the sensors have already been installed. If the walls are finished and the sensors unavailable, a user is unable to determine if conductive debris is causing a false trigger for the presence of a liquid. To protect the sensors from debris, a liquid-permeable insulator 1000 may at least partially envelop the sensor. The insulator 1000 prevents a nail, for example, from shorting the detection field. However, since the insulator is liquid-permeable, a liquid can saturate the insulator 1000 and create a low resistance across the detection field.

In one aspect (FIG. 10A), the insulator 1000 is a tube-like structure that completely surrounds the sensor. The sensor may be free to slide in the tube, or the sensor may be secured to the tube, so that the relative positions of the tube and sensor remain fixed. For visual clarity, an air cavity is shown between the tube top surface 1002 and the sensor top surface 104. However, in other aspects the tube surface 1002 is closely coupled to the first surface 104, to insure that a liquid saturating the insulator 1000 makes contact with the detection field. In other aspects not shown, an adhesive may be formed on the insulator bottom surface 1004 to secure the sensor to a surface. In another aspect not shown, a clamping mechanism, i.e., a cable tie, is attached to the insulator 1000.

Alternately as shown in FIG. 10B, the liquid-permeable insulator 1000 includes a first strip of material 1010 overlying the dielectric sheet first surface 104. This variation has less of an impact on flexibility and mounting, as the dielectric sheet second surface remains unencumbered. The insulation strip may be attached along one edge of the dielectric sheet first surface and held in place by the clamping mechanism used to secure the sensor to a pipe, for example. Alternately, the strip 1010 may be secured across both edges 1012 and 1014, and adhered across the entire surface 104. When a user seeks to make an electrical connection to the sensor, one edge of the insulator can be pulled away from surface 104. Insulator sheet 1010 can be used without impacting the mounting mechanisms described by FIGS. 5A through 7B. The liquid-permeable insulator of FIGS. 10A and 10B can be a material such as cardboard, burlap, cotton cloth, synthetic cloth, paper, crepe paper, or cheesecloth. However, the sensor is not limited to any particular material.

In a different aspect, the insulator sheet 1010 may be totally separate from the dielectric sheet 102, and it is only wrapped around or secured over the dielectric sheet after the dielectric sheet has been made mechanically secure. For example, the dielectric sheet made be mechanically secured to a pipe using an adhesive or a cable tie, and electrically connected to an alarm monitor. Then, the insulator sheet 1010 is wrapped around the dielectric sheet, secured to the dielectric sheet with an adhesive or over-wrapped with a cable tie.

In another aspect (FIG. 10C), the dielectric sheet and insulator are the same layer or sheet. For example, the dielectric/insulator 1120 may be paper, for example, a self-adhesive paper with conductive traces 202/204, i.e., wires, embedded in the paper. The paper protects the wires from direct contact, but water can be absorbed into the paper. Alternately, wires can be shown between a folded layer of cloth. Again, the cloth protects the wires from direct contact, but water is readily absorbed by the cloth.

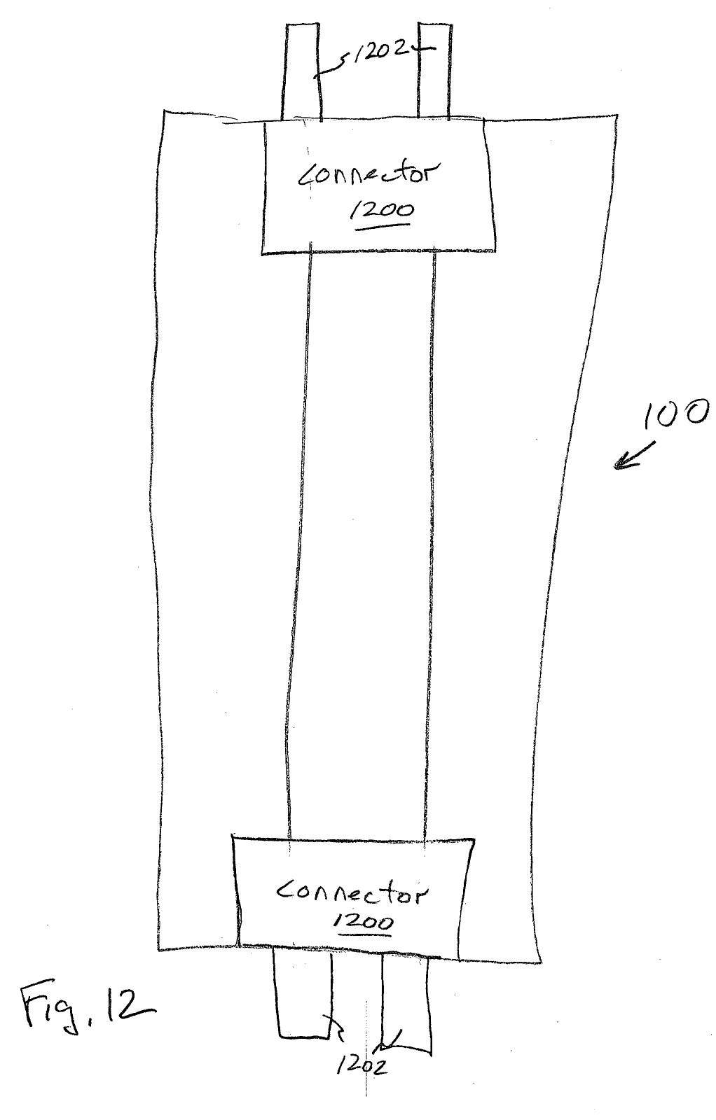

FIG. 11 is a perspective view of a feature that can be added to the sensor to address the problem of testing the sensor integrity. The sensor may include a test port to supply the conductive traces, so that it can be temporarily shorted to simulate a low resistance across the detection field. In a simple form, as shown, the test port may just supply wires 1100 and 1102 that are connected to the conductive traces 202 and 204. After testing, the wires can be cut or shortened to prevent the accidental occurrence of a short. In another aspect, a pressure-contact bridge 1104, with a conductive area 1106 (in phantom) can be used to temporarily create a short.

In a different aspect (not shown), the wires 1100 and 1102 can be connected to an electrical switch. Momentarily closing the electrical switch simulates a liquid in the detection field and, for the purpose of diagnostic testing.

### Functional Description

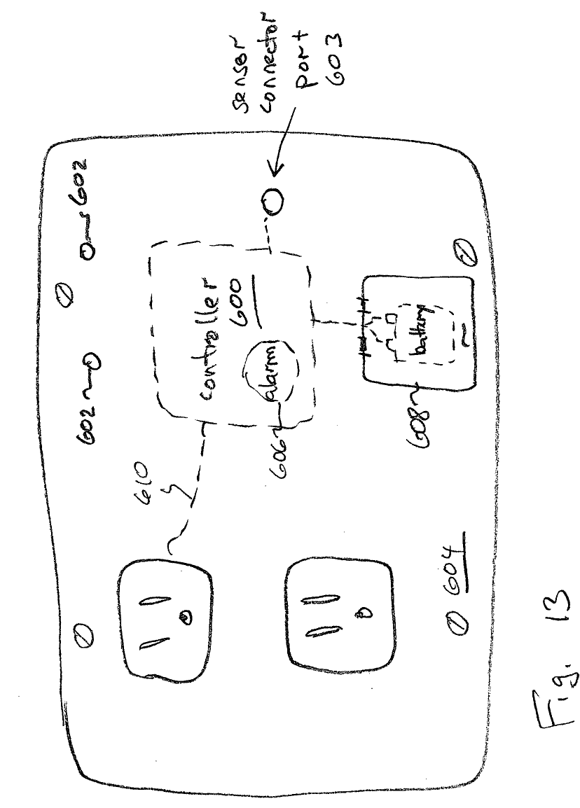

FIG. 12 is a plan view showing a sensor with a connector mounted to each connector end. Once installed, the sensor 100 is connected to a controller (not shown), which monitors the impedance of the sensor to determine the presence of a leak. Thus, the sensor supplies a resistance measurement responsive to liquid in the detection field (the area between conductive traces). The sensor may be daisy chain-connected or parallel-connected with other sensors, to become part of a field of sensors (not shown). The sensor is not limited to any particular type of connector. Note, the sensor is depicted with a connector 1200 on each end of the sensor, with mating pins 1202. Either connector may be connected to a controller, and the unused connector trimmed away or ignored. Both connectors may be used if the sensor is connected in a serial-connected field of sensors.

FIG. 13 is schematic block diagram of a wallplate sensor controller. The controller 600, shown in phantom behind wallplate face 604, includes a measurement circuit that is connected to a sensor, such as the flexible sensor of FIG. 1, to accept a resistance sum. The sensor connector 603 may be mounted in the face 604 of the wallplate, as shown. For example, a sensor may be mounted on a floor near the wallplate. Alternately but not shown, the connector 603 may be located behind the wallplate surface 604. For example, the sensor may be mounted on a pipe running in the wall behind wallplate controller 600, in which case the connection to the controller 600 can be made without going through the face 604.

The controller may operate by comparing the resistance sum (the resistance supplied by the sensor) to a threshold resistance or a previous resistance state, and supplying a control signal in response to the comparison. The controller may also include an alarm circuit 606 having an input to accept the control signal and an output to supply an alarm. The alarm may be audible, visual, a hardwired control signal, or a wireless alarm message to name a few examples. Further, the controller may include LEDs 602 to additionally indicate the above-mentioned alarm state, to indicate a defective or disconnected sensor, or a low voltage condition for example. In other aspects, the wallplate controller may include a battery for backup power, located behind access panel 608. The controller may also be connected to the AC power via line 610 for primary power. Further, the wallplate controller 600 may include AC outlets as shown, a light switch (not shown), or comprise just sensor-related circuitry.

The above-described sensor has many building construction-related applications. As noted above, the sensor can be wrapped around water pipes, to detect faulty connections behind walls or other areas that are not visually accessible. The sensors can be wrapped around water heaters. The sensor can be stapled to porous materials, such as a wooded 2×4 at the bottom inside of wall. The sensor can be taped to floors under carpets and areas where water must be avoided. The sensor can be taped to tile floors. Since the sensor flexes, it contours into the grout lines detecting water before it rises to the top of the tiles. The sensors can be taped to hardwood floors. Since the sensor can be made thin, it can even be attached under floorboards or carpet in critical areas, such as adjacent outside doorways, where water can seep under the door. The sensor can be taped at the edge of bathtubs and water containers to prevent overflows, placed at the bottom of freezers to detect defrosting due to equipment failure, or even placed under aquariums to detect leaks.

A flexible water detection sensor has been provided. Examples of sensor shapes, materials, and uses have been given to illustrate the invention. However, the invention is not limited to merely these examples. That is, the sensor may be used on surfaces other than pipes and floors. Examples have also been given of means of connecting these sensors and forming the connected sensors into a field. Again, examples have been given to clarify the invention, and the invention cannot be limited to just the examples. Other variations and embodiments of the present invention will occur to those skilled in the art.

1. A flexible liquid detection sensor comprising:
a flexible dielectric sheet with a first surface having a length; and,
a detection field, formed from a pair of conductive traces overlying the first surface of the flexible dielectric sheet, having a resistance responsive to a liquid overlying the conductive traces.

2. The sensor of claim 1 wherein the dielectric sheet has a selectable length; and,
wherein conduction field has an impedance characteristic independent of the selected length of the dielectric sheet.

3. The sensor of claim 1 further comprising:
a connector having a physical interface to mechanically secure a wiring harness to the dielectric sheet, and an electrical interface connected to the detection field to supply a resistance measurement responsive to liquid in the detection field.

4. The sensor of claim 3 wherein the connector physical interface is connectable at any position along the dielectric sheet length; and,
wherein the connector electrical interface supplies a resistance measurement independent of the connector physical interface position.

5. The sensor of claim 4 wherein the connector physical interface includes a clamping mechanism to physically secure the connector to the dielectric sheet; and,
wherein the electrical interface includes conductive pins, to at least partially penetrate the dielectric sheet and engage the conductive traces, in response to securing the clamping mechanism.

6. The sensor of claim 1 further comprising:
an adhesive strip attached to an end of the dielectric sheet, to secure the sensor to a surface.

7. The sensor of claim 1 further comprising:
a clamping mechanism attached to the dielectric sheet first surface, to wrap and secure the sensor around a circumference of a radial object.

8. The sensor of claim 7 wherein the clamping mechanism is selected from the group comprising a tie-wrap, an adhesive strip, cable tie, a hose clamp, a twist tie, Velcro strip, Velcro tie wrap, a wire, and a string.

9. The sensor of claim 1 wherein the dielectric sheet is a material selected from the group comprising paper, an insulating film with adhesive backing, a polyester film, a polyimide film, a synthetic aromatic polyamide polymer film, a phenolic sheet, a polytetrafluoroethylene (PTFE) sheet, a chlorosulfonated polyethylene film, a silicon sheet, and an ethylene propylene diene monomer (EPDM) film.

10. The sensor of claim 1 wherein the dielectric sheet is a polyimide film having a thickness of about 3 mils.

11. The sensor of claim 1 wherein the flexible dielectric sheet has a second surface; and,
the sensor further comprising:
an adhesive attached to the dielectric sheet second surface.

12. The sensor of claim 1 wherein the detection field includes a pair of conductive traces formed in a zipper pattern.

13. The sensor of claim 1 wherein the dielectric sheet includes a second surface; and,
the sensor further comprising:
a thermal insulation sheet attached to the dielectric sheet second surface.

14. The sensor of claim 1 further comprising:
a liquid-permeable insulator at least partially enveloping the sensor.

15. The sensor of claim 14 wherein the liquid-permeable insulator includes a first strip of material overlying the dielectric sheet first surface.

16. The sensor of claim 14 wherein the liquid-permeable insulator is a material selected from the group including cardboard, burlap, cotton cloth, synthetic cloth, paper, and cheesecloth.

17. The sensor of claim 1 wherein the detection field conductive traces are conductive ink printed on the dielectric sheet first surface.

18. The sensor of claim 1 further comprising:
a test port supplying wires, connected to the conductive traces, that can be shorted to simulate a low resistance across the detection field.

19. A flexible pipe leak detection sensor comprising:
a flexible dielectric sheet with a surface and a length;
a detection field, formed from a pair of conductive traces overlying the surface of the flexible dielectric sheet, having a resistance responsive to a liquid overlying the conductive traces; and,
a clamping mechanism attached to the dielectric sheet surface, to wrap and secure the sensor around a circumference of a pipe.

20. A flexible pipe leak detection sensor comprising:
a flexible dielectric sheet with a surface and a selectable length;
a detection field, formed from a pair of conductive traces overlying the surface of the flexible dielectric sheet, having a resistance responsive to a liquid overlying the conductive traces; and,
a liquid-permeable insulator at least partially enveloping the sensor.
